(19) United States
(12) Patent Application Publication
(10) Pub. No.: US 2006/0277354 A1
(43) Pub. Date: Dec. 7, 2006

(54) Library apparatus

(75) Inventor: Daisuke Tomii, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/228,561

(22) Filed: Sep. 16, 2005

(30) Foreign Application Priority Data
Jun. 7, 2005 (JP) 2005-166812

(51) Int. Cl. G06F 3/06

(52) U.S. Cl. 711/4

(57) ABSTRACT

The invention provides a library apparatus wherein provisions are made to be able to continue the entire operation of the library apparatus uninterrupted if a failure occurs in any one of the constituent elements of the library apparatus, with further provisions made to be able to identify the source of the failure. The library apparatus 1 comprises library controllers Lct1 and Lct2 configured in a redundant configuration and drive command paths P1 and P2 configured in a redundant configuration, wherein a library controller port on the library controller Lctl is configured redundantly by duplicating a port 14 with a port 15, the ports 14 and 15 being connected to the redundantly configured drive command paths P1 and P2, respectively, and a library controller port on the library controller Lct2 is configured redundantly by duplicating a port 24 with a port 25, the ports 24 and 25 being connected to the redundantly configured drive command paths P1 and P2, respectively.

### CROSS REFERENCE TO RELATED APPLICATION

This application is based upon and claims the benefit of priority from the prior Japanese Patent Application No. 2005-166812, filed on Jun. 7, 2005, the entire contents of which are incorporated herein by reference.

### BACKGROUND OF THE INVENTION

1. Field of the Invention

The present invention relates to a library apparatus for writing and reading data recorded on a recording medium such as a magnetic tape, a magnetic disk, or a magneto-optical disk.

2. Description of the Related Art

In recent years, many database systems and electronic filing systems, because of the need to store huge amounts of data, have come to employ library apparatuses in which a large number of electronic data recording media are stored and which are used to write and read data recorded on the recording media. FIG. 12 shows the basic configuration of a prior art library apparatus.

The library apparatus 1 comprises: a library controller Lct which controls the entire operation of the library apparatus 1 in accordance with control instructions from a host 2; a plurality of drive controllers Dct1, Dct2, . . . , and Dctn which control their connected recording medium drive units D11 and D12, D21 and D22, . . . , and Dn1 and Dn2, respectively, in accordance with control instructions from the library controller Lct; and a drive command path P which connects the library controller Lct with the drive controllers Dct1, Dct2, . . . , and Dctn.

The library controller Lct is provided with a library controller port 14 which is connected to the drive command path P and via which the library controller Lct transmits control instructions to the respective drive controllers Dct1, Dct2, . . . , and Dctn and receives status information from the respective drive controllers Dct1, Dct2, . . . , and Dctn; on the other hand, the drive controllers Dct1, Dct2, . . . , and Dctn are provided with drive controller ports 31, 41, . . . , and 51, respectively, each of which is connected to the drive command path P, and via which the respective drive controllers Dct1, Dct2, . . . , and Dctn transmit status information to the library controller Lct and receive control instructions from the library controller Lct.

When an electronic data read or write instruction is received from the host 2, the library controller Lct identifies where the electronic data to be read or written is located, and determines the drive unit with which the requested data is to be read from or written to, from among the drive units D11 to Dn2. Then, the library controller Lct transmits the electronic data read or write instruction via the drive command path P to the drive controller that controls the thus determined drive unit.

The drive controller that received the electronic data read or write instruction performs control to read or write the requested data on the drive unit determined by the library controller Lct.

In this case, when the instruction received via the drive command path P is a write instruction, the electronic data to be written is transferred via a drive path (not shown) connecting between the host and the drive unit and written to the drive unit. On the other hand, when the instruction received via the drive command path P is a read instruction, the electronic data read from the drive unit is transferred to the host 2 via the above drive path (not shown).

### SUMMARY OF THE INVENTION

As shown, the prior art library apparatus 1 employs a nonredundant configuration for the library controller Lct, the drive controllers Dct1, Dct2, . . . , and Dctn, the drive command path P, and the ports 14, 31, 41, . . . , and 51. As a result, there has been the problem that, if a communication failure occurs between the library controller Lct and any one of the drive units D11 to Dn2, there is no knowing which of the devices located along the intervening path is responsible for the failure.

In particular, as the library controller Lct, the drive command path P, and the library controller port 14 are each constructed from a single device, if a failure occurs in any of these devices, there arises not only the problem that the source of the failure cannot be identified, but the entire operation of the library apparatus 1 cannot be continued.

Furthermore, because of the inability to identify the source of the failure, the library apparatus 1 that employs such a nonredundant configuration has had the problem that, in order to restore the service quickly, all the affected parts, including non-failing parts, have to be replaced, which is uneconomical.

The present invention has been devised in view of the above problems, and an object of the invention is to provide a library apparatus wherein provisions are made to be able to continue the entire operation of the library apparatus uninterrupted if a failure occurs in any one of the constituent elements of the library apparatus.

It is another object of the present invention to provide a library apparatus wherein provisions are made to be able to identify the source of the failure that occurred in any one of the constituent elements.

To achieve the above object, in the library apparatus according to the present invention, the library controller, the drive command path, and the library controller port to be connected to the drive command path are each configured in a redundant configuration.

In this case, the drive command path may be configured redundantly by duplicating a first drive command path with a second drive command path, and the library controller port may be configured redundantly by duplicating a library controller first port with a library controller second port on each of the redundantly configured library controllers; here, the library controller first port and the library controller second port may be connected to the first drive command path and the second drive command path, respectively.

Further, the library apparatus according to the present invention may include a source-of-failure determining section for determining the source of a failure occurring in any one of the library controller, the drive command path, and the library controller port.

Further, in the library apparatus according to the present invention, drive controller ports to be connected to the drive command path are each configured redundantly by duplicating a drive controller first port with a drive controller second port on each drive controller, and the drive controller first ports on each drive controllers are connected in parallel for connection to the first drive command path, while the drive controller second ports on each drive controllers are connected in parallel for connection to the second drive command path.

In this case, the library apparatus according to the present invention may include a source-of-failure determining section for determining the source of a failure occurring in any one of the library controller, the drive controllers, the drive command path, the library controller port, and the drive controller ports.

In the library apparatus according to the present invention described above, the library controller and the drive controllers may each include a communication section for communicating with each other, and the source-of-failure determining section may be configured to detect the occurrence of the failure when an abnormality occurs in the communication between the communication sections.

### BRIEF DESCRIPTION OF THE DRAWINGS

The present invention will be more clearly understood from the description as set forth below with reference to the accompanying drawings, wherein:

FIG. 1 is a diagram showing the basic configuration (first configuration) of a library apparatus according to the present invention;

FIG. 2 is a diagram showing the basic configuration (second configuration) of the library apparatus according to the present invention;

FIG. 3 is a diagram showing the configuration of a first embodiment of the library apparatus according to the present invention;

FIG. 4 is a flowchart illustrating the general operation of the library apparatus shown in FIG. 3;

FIG. 5 is a flowchart of a subroutine S13 shown in FIG. 4;

FIG. 6 is a flowchart of a subroutine S14 shown in FIG. 4;

FIG. 7 is a diagram showing the configuration of a second embodiment of the library apparatus according to the present invention;

FIG. 8 is a flowchart illustrating the general operation of the library apparatus shown in FIG. 7;

FIG. 9 is a flowchart of a subroutine S42 shown in FIG. 8;

FIG. 10 is a flowchart of a subroutine S52 shown in FIG. 9;

FIG. 11 is a flowchart of a subroutine S53 shown in FIG. 9; and

FIG. 12 is a diagram showing the basic configuration of a prior art library apparatus.

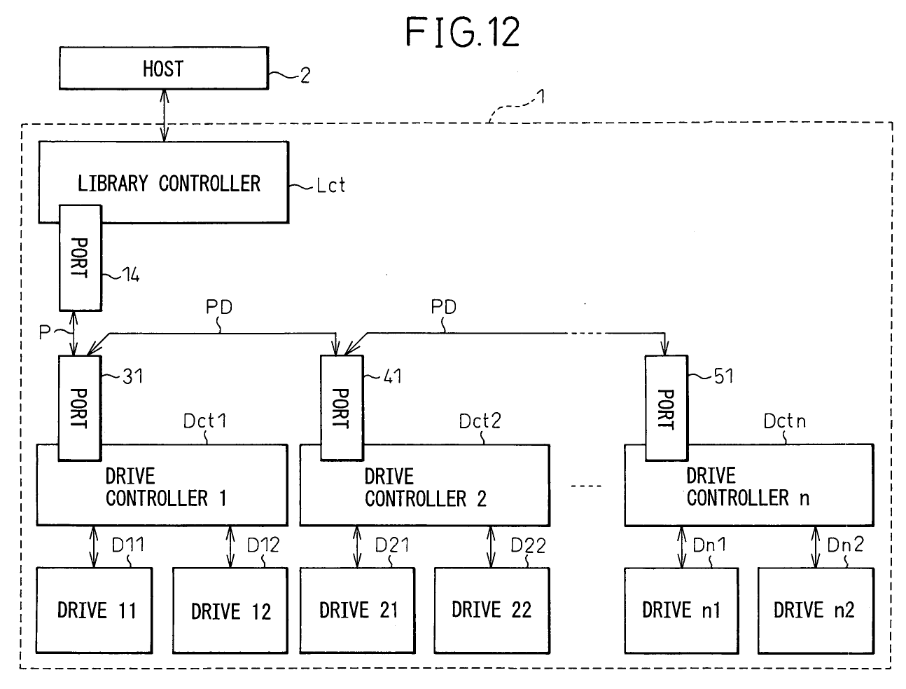

### DESCRIPTION OF THE PREFERRED EMBODIMENTS

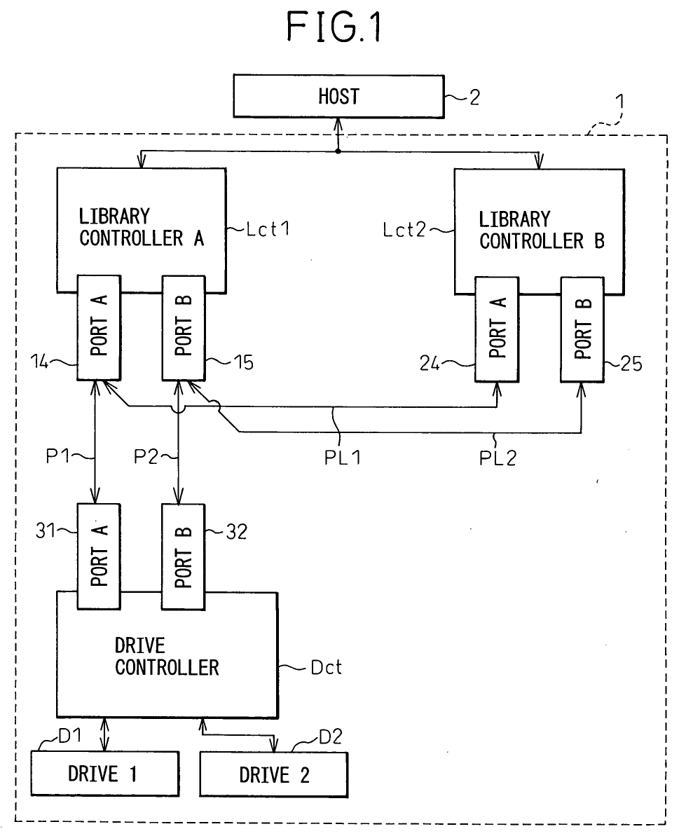

A first basic configuration of a library apparatus according to the present invention will be described below with reference to FIG. 1.

The library apparatus 1 comprises: library controllers Lct1 and Lct2 which control the entire operation of the library apparatus 1 in accordance with a control instruction from a host 2; a drive controller Dct which controls its connected storage medium drive units D1 and D2 in accordance with a control instruction from the library controllers Lct1 and Lct2; and drive command paths P1 and P2 which connect the library controllers Lct1 and Lct2 with the drive controller Dct.

The library controllers Lct1 and Lct2 are constructed by duplicating the first library controller Lct1 using the second library controller Lct2 having the same function in order to provide redundancy, the design being such that when one controller is in a working (active) state, the other is in a standby state. If the active controller fails, the standby controller is switched in to replace the failed controller which is placed in the standby state, and the entire operation of the library apparatus 1 can thus be continued uninterrupted.

The drive command paths P1 and P2 are also configured redundantly by duplicating the first drive command path P1 with the second drive command path P2, both implemented using identical signal lines, etc., and when one is in the working (active) state, the other is in the standby state.

Further, library controller ports provided on each of the first and second library controllers Lct1 and Lct2 for connecting these controllers to the respective drive command paths P1 and P2 are also configured in a redundant configuration, that is, the library controller first port 14 and the library controller second port 15 are provided on the first library controller Lct1, while the library controller first port 24 and the library controller second port 25 are provided on the second library controller Lct2.

Here, the library controller first ports 14 and 24 are connected in parallel by a first inter-Lct connecting drive command path PL1 for connection to the first drive command path P1; likewise, the library controller second ports 15 and 25 are connected in parallel by a second inter-Lct connecting drive command path PL2 for connection to the second drive command path P2.

Furthermore, drive controller ports provided on the drive controller Dct for connection to the respective drive command paths P1 and P2 are also configured redundantly by duplicating the drive controller first port 31 with the drive controller second port 32; here, the drive controller first port 31 is connected to the first drive command path P1, and the drive controller second port 32 is connected to the second drive command path P2.

Of the first and second library controllers Lct1 and Lct2, the working (active) library controller (hereinafter, for purposes of explanation, it is assumed that the first library controller Lct1 is the active controller) can detect that a failure has occurred somewhere along the intervening path between the first library controller Lct1 and the drive unit D1 or D2, if no communication response is returned from the drive unit D1 or D2 within a predetermined time interval.

Alternatively, communication units for communicating with each other via the drive command path P1 or P2 may be provided in the library controller Lct1 and the drive controller Dct, respectively, and the library controller Lct1 may be constructed to detect that a failure has occurred somewhere along the intervening path between the first library controller Lct1 and the drive controller Dct, if an abnormality has occurred in the communication between the communication units.

Then, if the library controller Lct1 cannot communicate with the drive unit D1 or D2 via the currently active library controller port (for example, the first port 14) (or if the communication units provided in the library controller Lct1 and the drive controller Dct, respectively, cannot communicate with each other), but the communication is possible not only when the standby library controller port (for example, the second port 15) provided on the same library controller Lct1 is used but also when the library controller port 24 provided on the standby library controller Lct2 and connected to the same drive command path (the first drive command path P1) as the currently active library controller port 14 is used, then the library controller Lct1 determines that a failure has occurred in the currently active library controller port 14, and switches the active drive command path to the second drive command path P2 so that the operation of the library apparatus 1 can be continued.

On the other hand, if the library controller Lct1 cannot communicate with the drive unit D1 or D2 via the currently active library controller port 14 (or if the communication units provided in the library controller Lct1 and the drive controller Dct, respectively, cannot communicate with each other), and the communication is still not possible even when the library controller port 24 provided on the standby library controller Lct2 and connected to the same drive command path (the first drive command path P1) as the library controller port 14 is used, then the library controller Lct1 determines that a failure has occurred in the currently active drive command path P1, and switches the active drive command path to the second drive command path P2 so that the operation of the library apparatus 1 can be continued.

Further, if the library controller Lct1 cannot communicate with the drive unit D1 or D2 whether the first port 14 or the second port 15 of the library controller Lct1 is used (or if the communication units provided in the library controller Lct1 and the drive controller Dct, respectively, cannot communicate with each other), but the communication becomes possible when the standby library controller Lct2 is used, then the library controller Lct1 determines that the library controller Lct1 itself has failed, and switches the active library controller to the library controller Lct2 so that the operation of the library apparatus 1 can be continued.

In this way, when the constituent elements of the library apparatus 1, i.e., the library controller, the drive command path, and the library controller port connected to the drive command path, are each configured in a redundant configuration as described above, not only does it become possible to locate any failure occurring along the intervening path between the library controller and the drive command path, but even when a failure has occurred, the operation of the library apparatus 1 can be continued uninterrupted.

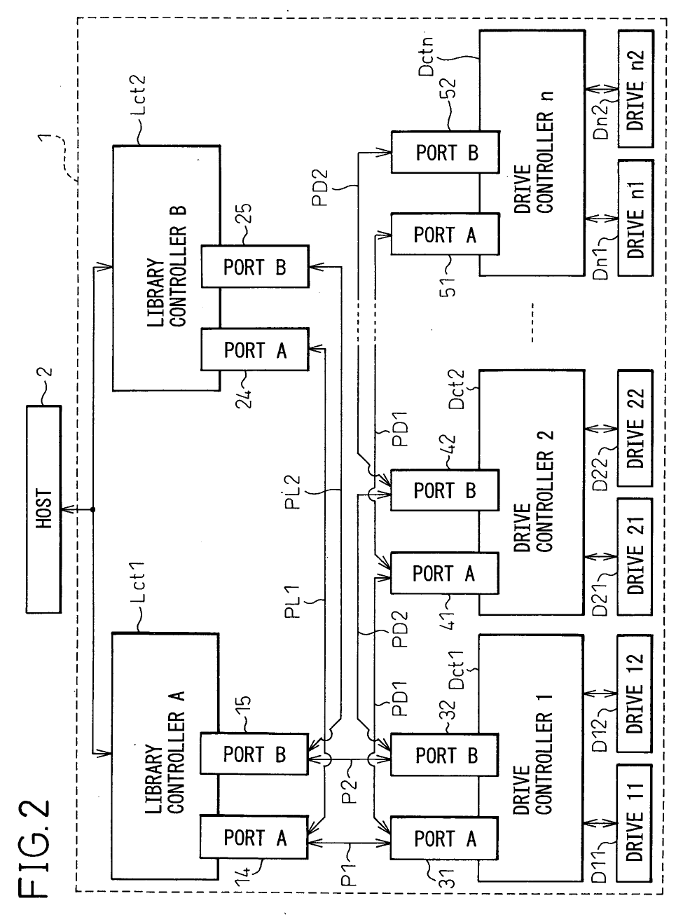

FIG. 2 shows a second basic configuration of the library apparatus according to the present invention.

The library apparatus shown in FIG. 2 includes a plurality of drive controllers Dct1, Dct2, . . . , and Dctn for controlling storage medium drive units D11 and D12, D21 and D22, . . . , and Dn1 and Dn2, respectively.

Here, the drive controllers and the storage medium drive units may be duplicated using the plurality of drive controllers Dct1 to Dctn and the plurality of storage medium drive units D11 to Dn2, respectively, or alternatively, the plurality of drive controllers Dct1 to Dctn and the plurality of storage medium drive units D11 to Dn2 may be respectively configured as nonredundant devices by assigning different storage areas to the respective drive units D11 to Dn2.

Even when the drive controllers Dct1 to Dctn and the storage medium drive units D11 to Dn2 are respectively configured as nonredundant devices, as these controllers or units are constructed by connecting a plurality of identical devices in parallel, if any one of them fails (for example, if Dct1 fails) the other devices (for example, Dct2 to Dctn) are usable, and thus the entire operation of the library apparatus 1 can be continued. It is also possible to identify the source of the failure by identifying the other usable devices.

Drive controller first ports 31, 41, . . . , and 51 on the respective drive controllers Dct1 to Dctn are connected in parallel by a first inter-Dct connecting drive command path PD1 for connection to the first drive command path P1, while drive controller second ports 32, 42, . . . , and 52 are connected in parallel by a second inter-Dct connecting drive command path PD2 for connection to the second drive command path P2.

In this way, in the library apparatus 1 according to the present invention, the library controller, the drive command path, the library controller port, and the drive controller port, which were respectively constructed from single components in the prior art library apparatus, are each configured in a redundant configuration.

With this configuration, all the constituent elements of the library apparatus 1 (the library controller, the drive command path, the library controller port, the drive controller, the drive controller port, and the storage medium drive unit) can each be constructed as an array of a plurality of elements connected in parallel, and the source of any failure occurring in any one of the constituent elements can be identified.

That is, when a failure occurs along the intervening path between the library controller and the drive command path, the source of the failure can be identified by using the method described with reference to FIG. 1.

For example, in the event of failure of the currently active drive controller port (for example, the port 31) on the drive controller Dct1, if the library controller Lct1 can communicate with any one of the storage medium drive units operating under control of any one of the other drive controllers Dct2 to Dctn (or can communicate with any one of the other drive controllers Dct2 to Dctn) by using the currently active drive command path P1, and if it becomes possible to communicate with the drives 11 and 12 operating under control of the drive controller Dct1 (or communicate with the drive controller Dct1) when the drive command path is switched to P2, then it can be determined that the drive controller port 31 is faulty. In this case, the operation of the library apparatus 1 is continued by switching the active drive command path to the second drive command path P2.

Further, in the event of failure of a drive controller (for example, Dct1), if the library controller Lct1 can communicate with any one of the storage medium drive units operating under control of any one of the other drive controllers Dct2 to Dctn (or can communicate with any one of the other drive controllers Dct2 to Dctn) by using the currently active drive command path P1, but still cannot communicate with the drive 11 or 12 operating under control of the drive controller Dct1 (or cannot communicate with the drive controller Dct1) even when the drive command path is switched to P2, then it is determined that drive controller Dct1 is faulty.

In this case, if the drive controllers are not configured for redundancy, the library controller Lct1 prohibits access to the storage medium drive units 11 and 12 operating under control of the drive controller Dct1.

On the other hand, in the event of failure of a storage medium drive unit (for example, D11), if the library controller Lct1 can communicate with any one of the storage medium drive units operating under control of any one of the other drive controllers Dct2 to Dctn (or can communicate with any one of the other drive controllers Dct2 to Dctn) by using the currently active drive command path P1, and can also communicate with the other storage medium drive unit D12 operating under control of the same drive controller Dct1, then it is determined that the storage medium drive unit D11 is faulty.

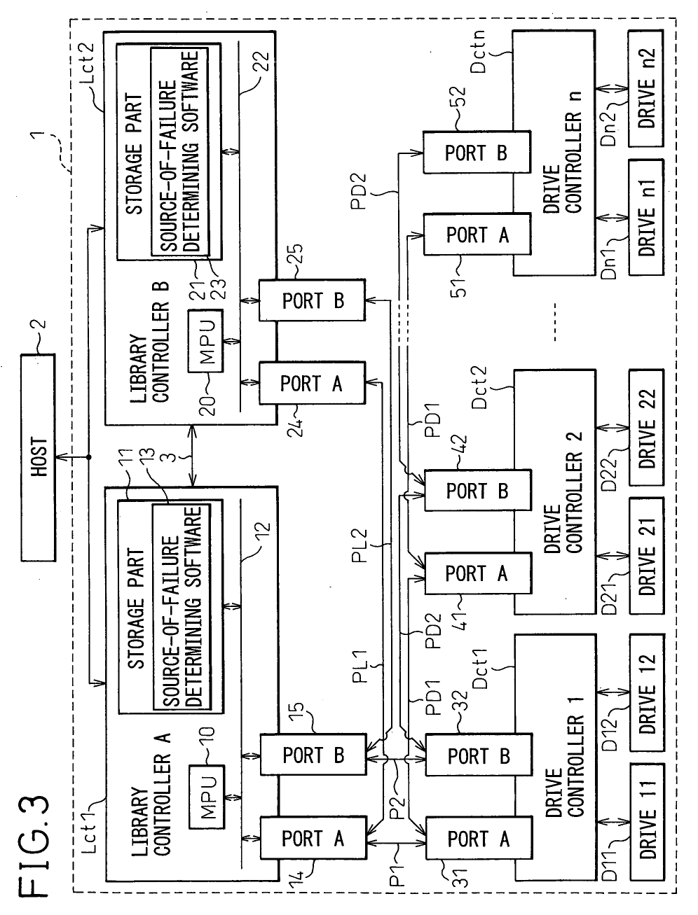

Next, preferred embodiments of the library apparatus according to the present invention will be described with reference to the accompanying drawings. FIG. 3 is a diagram showing the configuration of a first embodiment of the library apparatus according to the present invention.

The library apparatus 1 comprises: a first library controller Lct1 and a second library controller Lct2 which control the entire operation of the library apparatus 1 in accordance with a control instruction from a host 2; a plurality of drive controllers Dct1, Dct2, . . . , and Dctn which control their connected storage medium drive units D11 and D12, D21 and D22, . . . , and Dn1 and Dn2, respectively, in accordance with a control instruction from the library controllers Lct1 and Lct2; and a first drive command path P1 and a second drive command path P2 which connect the library controllers Lct1 and Lct2 with the drive controllers Dct1 to Dctn.

The first library controller Lct1 comprises: an MPU 10 for executing various kinds of processing for controlling the entire operation of the library apparatus 1; a storage part 11, implemented by a memory device or the like, for storing programs defining the processing to be executed by the MPU 10 and data such as work data necessary for the execution of the programs; and first and second library controller ports 14 and 15 each of which is connected to a data bus 12 of the MPU 10 and via which the library controller Lct1 transmits the control instruction to the drive controllers Dct1 to Dctn and receives status information from the drive controllers Dct1 to Dctn.

The storage part 11 stores therein source-of-failure determining software 13 for the MPU 10 in the first library controller Lct1 to determine the source of a failure within the library apparatus 1 in accordance with a flowchart to be described later.

The second library controller Lct2 is identical in configuration to the first library controller Lct1; that is, the controllers Lct1 and Lct2 are configured redundantly, the design being such that when one of them is in the working (active) state, the other is in the standby state, and such that if the active controller fails, the standby controller is switched in to replace the failed controller which is placed in the standby state.

An inter-library-controller communication line 3 is provided between the first library controller Lct1 and the second library controller Lct2. As will be described later, the inter-library-controller communication line 3 is used when one of the library controllers Lct1 and Lct2 notifies the other library controller whether the one library controller is in the active state or the standby state, or when querying one library controller from the other library controller as to whether the one library controller can transmit and receive instructions to and from the storage medium drive units D11 to Dn2 or whether the one library controller can communicate with the drive controllers Dct1 to Dctn.

The drive command paths P1 and P2 are also configured redundantly by duplicating the first drive command path P1 with the second drive command path P2, both implemented using identical signal lines, etc. Further, the library controller ports provided on the first library controller Lct1 are also configured redundantly by duplicating the library controller first port 14 using the library controller second port 15, both implemented using identical communication interface circuits; likewise, the library controller ports provided on the second library controller Lct2 are configured redundantly by duplicating the library controller first port 24 using the library controller second port 25.

The library controller first ports 14 and 24 are connected in parallel for connection to the first drive command path P1, while the library controller second ports 15 and 25 are connected in parallel for connection to the second drive command path P2. Here, the library controller first port 24 on the second library controller Lct2 is connected in parallel with the library controller first port 14 by the first inter-Lct connecting drive command path PL1 for connection to the first drive command path P1, while the library controller second port 25 on the second library controller Lct2 is connected in parallel with the library controller second port 15 by the second inter-Lct connecting drive command path PL2 for connection to the second drive command path P2.

The drive controller ports provided on each of the drive controllers Dct1 to Dctn are also configured redundantly.

That is, the ports on the dive controller Dct1 are redundantly configured by duplicating the drive controller first port 31 using the drive controller second port 32, and the ports on the dive controller Dct2 are redundantly configured by duplicating the drive controller first port 41 using the drive controller second port 42, while the ports on the dive controller Dctn are redundantly configured by duplicating the drive controller first port 51 using the drive controller second port 52.

Then, the drive controller first ports 31 to 51 are connected in parallel for connection to the first drive command path P1, while the drive controller second ports 32 and 52 are connected in parallel for connection to the second drive command path P2.

Here, the first ports 41 to 51 on the drive controllers Dct2 to Dctn are connected to the first drive command path P1 via the first inter-Dct connecting drive command path PD1, while the second ports 42 to 52 on the drive controllers Dct2 to Dctn are connected to the second drive command path P2 via the second inter-Dct connecting drive command path PD2.

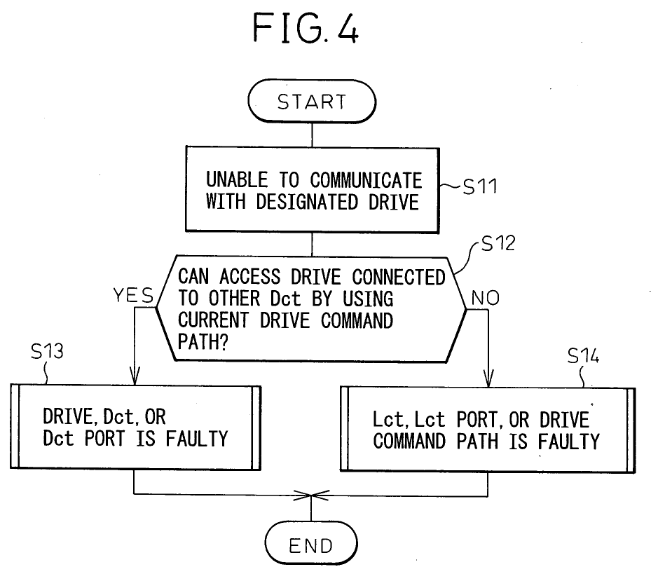

FIGS. 4 to 6 are flowcharts illustrating the source-of-failure detection process performed in the library apparatus 1 according to the present invention. This source-of-failure detection process is executed by the MPU 10 in the first library controller Lct1 (or the MPU 20 in the second library controller Lct2) performing operations in accordance with the source-of-failure determining software 13 (23) stored in the storage part 11 (21).

In the following description, it is assumed that, of the redundantly configured library controllers, drive command paths, library controller ports, and drive controller ports, the first library controller Lct1, first drive command path P1, library controller first port 14, and drive controller first port 31 are in the active state, while the second library controller Lct2, second drive command path P2, library controller second ports 15 and 25, library controller first port 24, and drive controller second port 32 are in the standby state.

In step S11 shown in FIG. 4, the library controller Lct1 transmits and receives instructions to and from a particular storage medium drive (for example, D11) at predetermined intervals of time (for example, every one second), and detects that a failure has occurred somewhere along the intervening path between the library controller Lct1 and the storage medium drive D11, if no response is returned within a predetermined time interval.

Next, in step S12, the library controller Lct1 tries to transmit and receive instructions, using the currently active drive command path P1, to and from the storage medium drives D21 to Dn1 operating under control of any one of the other drive controllers Dct2 to Dctn.

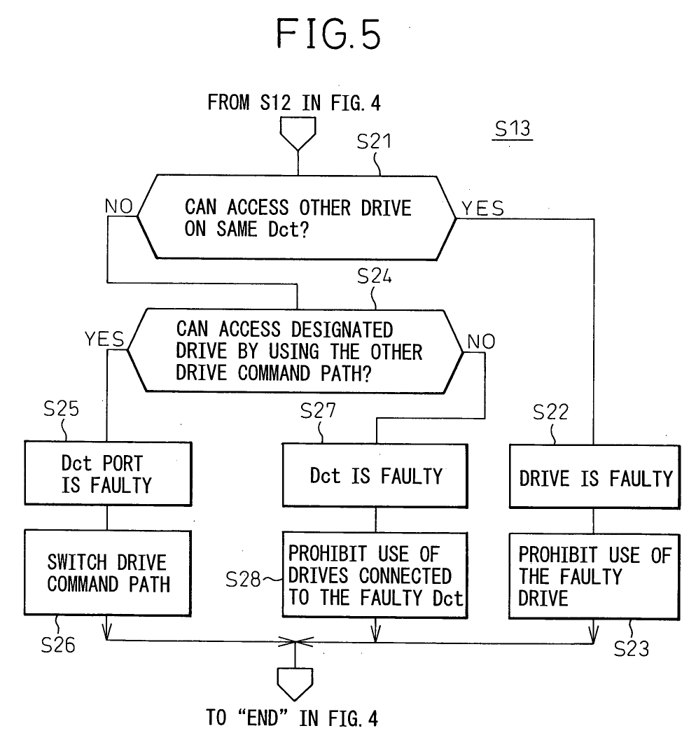

Here, if the transmission/reception of instructions to and from these storage medium drives D21 to Dn1 is possible, then the library controller Lct1 determines that a failure has occurred in either the drive D11, the drive controller Dct1, or the drive controller first port 31, and causes the process to branch to the routine S13 shown in FIG. 5.

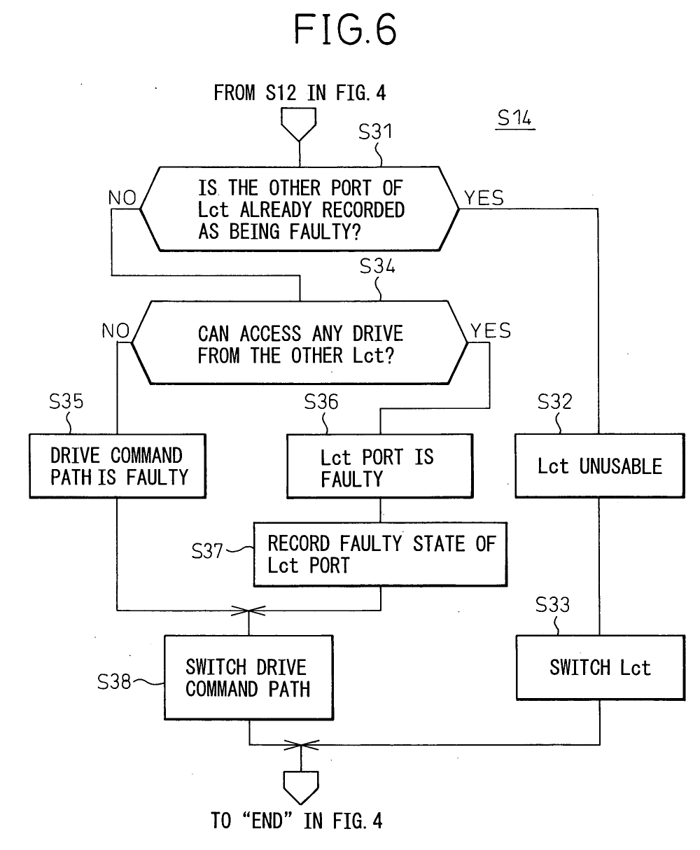

On the other hand if the transmission/reception of instructions to and from any one of the storage medium drives D21 to Dn1 is not possible, the library controller Lct1 determines that a failure has occurred in either the library controller Lct1 itself, the library controller first port 14, or the first drive command path P1, and causes the process to branch to the routine S14 shown in FIG. 6.

When the process branches to the routine S13 shown in FIG. 5 as a result of the determination in step S12, the library controller Lct1 in step S21 transmits and receives instructions to and from the other drive D12 connected to the same drive controller Dct1 that controls the drive D11. If, at this time, the transmission/reception of instructions to and from the other drive D12 is possible, the library controller Lct1 determines in step S22 that the source of the failure is the drive D11; then, the process proceeds to step S23 where the use of the drive D11 is prohibited until it is repaired or replaced, and the process is terminated.

On the other hand, if the transmission/reception of instructions to and from the other drive D12 is not possible, then in step S24 the library controller Lct1 tries to transmit and receive instructions to and from the drive D11 by using the second drive command path P2 currently in the standby state.

If the transmission/reception of instructions to and from the drive D11 is possible when the second drive command path P2 is used, the library controller Lct1 determines in step S25 that the drive controller first port 31 is faulty, and in step S26, the library controller Lct1 switches the second drive command path P2 to the active state and the first drive command path P1 to the standby state, thereby allowing the operation of the library apparatus 1 to be continued uninterrupted.

If the transmission/reception of instructions to and from the drive D11 is not possible even when the second drive command path P2 is used, the library controller Lct1 determines in step S27 that the first drive controller Dct1 is faulty, and the process proceeds to step S28 where the use of the drives D11 and D12 connected to the first drive controller Dct1 is prohibited until the first drive controller Dct1 is repaired or replaced.

When the process branches to the routine S14 shown in FIG. 6 as a result of the determination in step S12 in FIG. 4, the library controller Lct1 in step S31 checks to see if the reserve second port 15 on the library controller Lct1 is already recorded as being in a faulty state (to be described later with reference to step S37).

If the second port 15 is already in a faulty state, the library controller Lct1 cannot access any one of the drive units D11 to Dn2 whichever port, the first port 14 or the second port 15, is used; therefore, in step S32, the library controller Lct1 determines that the library controller Lct1 itself is faulty, and in step S33, the library controller Lct1 is placed in the standby state, while switching the library controller Lct2 to the active state, and thereafter the operation of the library apparatus 1 is continued using the library controller Lct2.

In one method of switching the active system from the library controller Lct1 to the library controller Lct2, the first library controller Lct1 that has determined in step S31 that its first and second ports are both unusable, for example, switches by itself to the standby state and, at the same time, sends an instruction via the inter-library-controller communication line 3 to the second library controller Lct2, instructing it to switch to the active state.

Alternatively, an active Lct switching means (not shown) for switching the active system between the library controllers Lct1 and Lct2 may be provided within the library apparatus 1; in this case, the first library controller Lct1 that has determined that its first and second ports are both unusable notifies the active Lct switching means accordingly, and the active Lct switching means then switches the active system from the library controller Lct1 to the library controller Lct2.

If it is determined in step S31 that the second port 15 on the first library controller Lct1 is not faulty, then in step S34 the first library controller Lct1 sends a query to the second library controller Lct2 via the inter-library-controller communication line 3, querying the second library controller Lct2 as to whether it can transmit and receive instructions to and from any one of the drive units D11 to Dn2 by using the drive command path P1.

Here, if the second library controller Lct2 also cannot transmit and receive instructions to and from any one of the drive units D11 to Dn2, it is determined in step S35 that the first drive command path P1 is faulty, and in step S38, the active drive command path is switched from the currently used first drive command path P1 to the reserve second drive command path P2, after which the process is terminated.

In this case, if, for example, the transmission/reception of instructions to and from the drive D11 or D12 connected to the drive controller Dct1 is possible, but the transmission/reception of instructions to and from any one of the drives D21 to Dn2 connected to the drive controller Dct2 to Dctn is not possible, then there is the possibility that the inter-Dct connecting drive command path PD1 or PD2 connecting between the drive controllers Dct1 and Dct2 is faulty. Here, provisions may be made to detect the failure of the inter-Dct connecting drive command path PD1 or PD2 by checking if the transmission/reception of instructions to and from the drives D21 to Dn2 connected to the drive controller Dct2 to Dctn becomes possible when the drive command path is switched to the standby drive command path.

On the other hand, if the second library controller Lct2 can transmit and receive instructions to and from any one of the drive units D11 to Dn2, it is determined in step S36 that the first port 14 on the first library controller Lct1 is faulty, and in step S37, the faulty state of the first port 14 is stored in the storage part 11; then, the active drive command path is switched from the currently used first drive command path P1 to the reserve second drive command path P2, after which the process is terminated.

As described above, according to the configuration of the library apparatus 1 shown in FIG. 3, the library controller Lct1 transmits and receives instructions to and from the storage medium drives D11 to Dn2, and detects that a failure has occurred somewhere along the intervening path between the library controller Lct1 and the storage medium drive D11, if no response is returned within a predetermined time interval.

However, according to the above method, each time the transmission/reception of instructions to and from the drives D11 to Dn2 is performed at a designated point in the source-of-failure determining flow (for example, step S12 in FIG. 4, steps S21 and S24 in FIG. 5, and step S34 in FIG. 6), a waiting time occurs to wait for a response from the storage medium drive; there is therefore the possibility that the source-of-failure determining flow may not be completed within the allowable response time to the host 2.

In view of this, in a second embodiment of the library apparatus 1 hereinafter proposed, communication units for communicating with each other are provided in the respective library controllers and drive controllers, and the occurrence of a failure is detected when abnormality occurs in the communication between the communication units. As such communication units allow the waiting time to be set shorter than the configuration that has to wait for a response from the storage medium drive, the source-of-failure determining flow can be completed in a shorter time by detecting the presence or absence of abnormality in the communication between the communication units and thereby checking for the presence or absence of any failure occurring along the intervening path between the library controller and the drive controller.

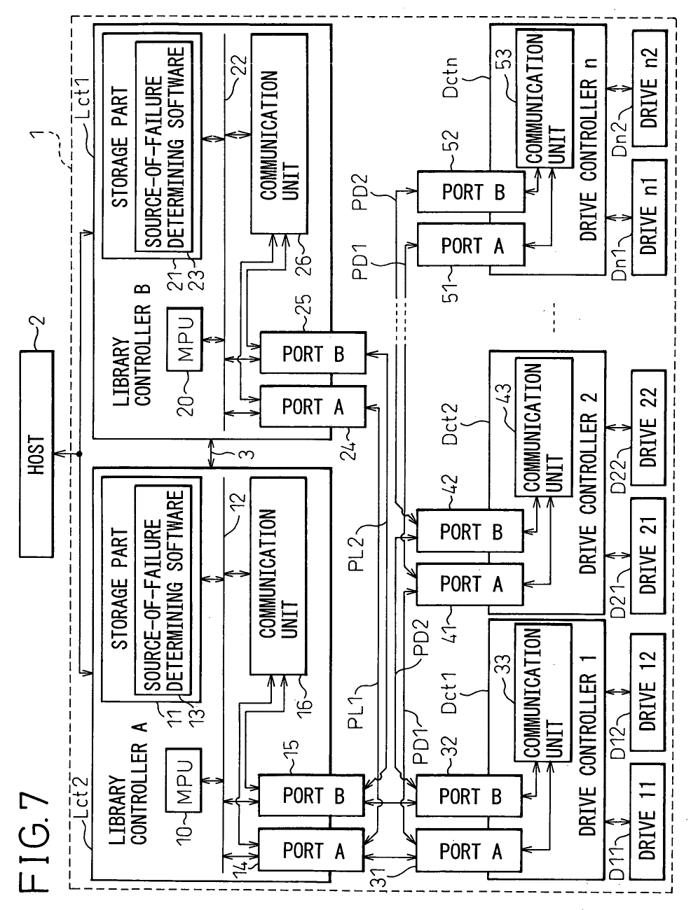

FIG. 7 is a diagram showing the configuration of the library apparatus according to the second embodiment of the present invention.

As shown, the first library controller Lct1 is provided with a library controller communication unit 16 that can communicate with the drive controller communication units 33, 43, . . . , and 53 provided in the respective drive controllers Dct1, Dct2, . . . , and Dctn.

Communication between the library controller communication unit 16 and the drive controller communication unit 33 is performed via the library controller first port 14, first drive command path P1, and drive controller first port 31, or via the library controller second port 15, second drive command path P2, and drive controller second port 32, and a query and a response about information such as the connection, power on/off status, etc. concerning the drives connected to the respective drive controllers Dct1, Dct2, . . . , and Dctn, for example, are transferred at predetermined intervals of time (for example, every 11 milliseconds).

Likewise, the second library controller Lct2 is provided with a library controller communication unit 26 that can communicate with the drive controller communication units 33, 43, . . . , and 53 provided in the respective drive controllers Dct1, Dct2, . . . , and Dctn.

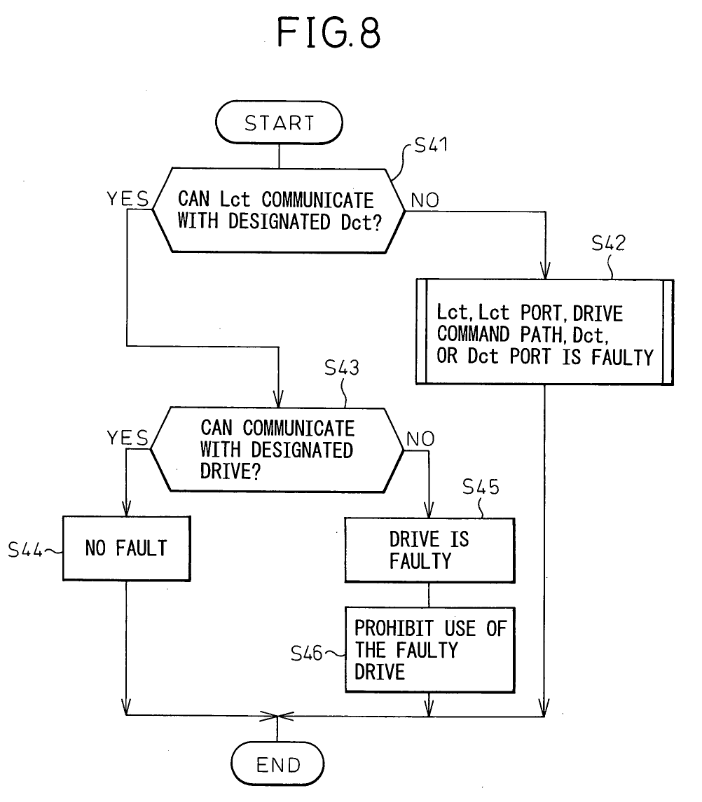

FIGS. 8 to 11 are flowcharts illustrating the source-of-failure detection process performed in the library apparatus 1 shown in FIG. 7.

In step S41 in FIG. 8, the library controller Lct1 determines whether its communication unit 16 can communicate with the communication unit 33 in the drive controller Dct1 controlling a particular storage medium drive (for example, D11).

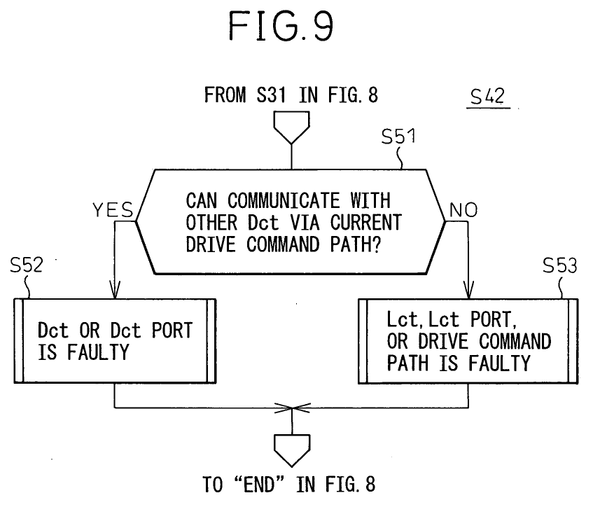

Here, if the communication unit 16 cannot communicate with the communication unit 33, the library controller Lct1 determines that a failure has occurred in either the library controller Lct1 itself, the library controller first port 14, the first drive command path P1, the drive controller Dct1, or the drive controller first port 31, and causes the process to branch to the routine S42 shown in FIG. 9.

On the other hand, if it is determined in step S41 that the communication unit 16 can communicate with the communication unit 33, then in step S43 the library controller Lct1 transmits and receives instructions to and from the drive D11; if a response is returned within a predetermined time interval, it is determined in step S44 that there is no fault, and the process is thus terminated.

Conversely, if no response is returned, then it is determined in step S45 that a failure has occurred in the drive D11, and the process proceeds to step S46 where the use of the drive D11 is prohibited until it is repaired or replaced, after which the process is terminated.

If, in step S41, the communication unit 16 cannot communicate with the communication unit 33, the process branches to the routine S42 shown in FIG. 9. In step S51 in FIG. 9, the library controller Lct1 has its communication unit 16 try to communicate with any one of the communication units 43 to 53 provided in the other drive controllers Dct2 to Dctn by using the currently active first drive command path P1.

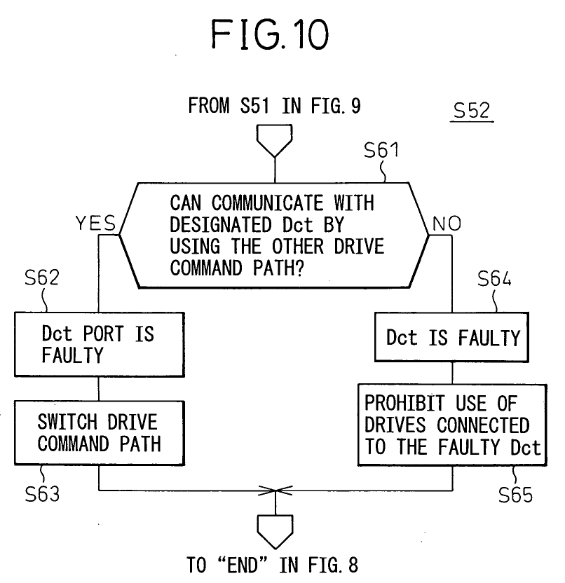

Here, if the communication unit 16 can communicate with any one of the communication units 43 to 53, the library controller Lct1 determines that a failure has occurred in either the drive controller Dct1 or the drive controller first port 31, and causes the process to branch to the routine S52 shown in FIG. 10.

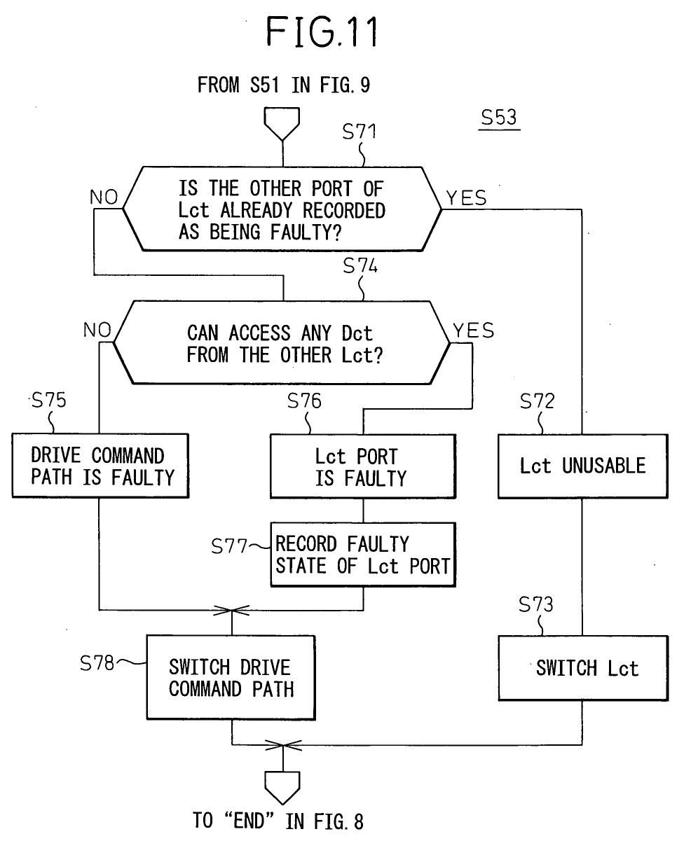

Conversely, if the communication unit 16 cannot communicate with any one of the communication units 43 to 53, the library controller Lct1 determines that a failure has occurred in either the library controller Lct1 itself, the library controller first port 14, or the first drive command path P1, and causes the process to branch to the routine S53 shown in FIG. 11.

When the process branches to the routine S52 shown in FIG. 10 as a result of the determination in step S51, in step S61 the library controller Lct1 has its communication unit 16 try to communicate with the communication unit 33 in the drive controller Dct1 controlling the drive D11, by using the reserve second drive command path P2.

If the communication unit 16 can communicate with the communication unit 33 when the second drive command path P2 is used, the library controller Lct1 determines in step S62 that the drive controller first port 31 is faulty, and in step S63, the first drive command path P1 is placed in the standby state, while switching the second drive command path P2 to the active state, thereby continuing the operation of the library apparatus 1.

If the communication unit 16 cannot communicate with the communication unit 33 even when the second drive command path P2 is used, the library controller Lct1 determines in step S64 that the first drive controller Dctl is faulty, and the process proceeds to step S65 where the use of the drives D11 and D12 connected to the first drive controller Dct1 is prohibited until the first drive controller Dct1 is repaired or replaced.

When the process branches to the routine S53 shown in FIG. 11 as a result of the determination in step S51 in FIG. 9, the library controller Lct1 in step S71 checks to see if the reserve second port 15 on the library controller Lct1 is already recorded as being in a faulty state.

If the second port 15 is already in a faulty state, the library controller Lct1 determines in step S72 that the library controller Lct1 itself is faulty, and in step S73, the library controller Lct1 is placed in the standby state, while switching the library controller Lct2 to the active state, and thereafter the operation of the library apparatus 1 is continued using the library controller Lct2. Here, the active system can be switched from the library controller Lct1 to the library controller Lct2 by using the same method as that described in the first embodiment of the library apparatus 1 shown in FIG. 3.

If it is determined in step S71 that the second port 15 on the first library controller Lct1 is not faulty, in step S74 the first library controller Lct1 sends a query to the second library controller Lct2 via the inter-library-controller communication line 3, querying the second library controller Lct2 as to whether its communication unit 26 can communicate with any one of the communication units 33 to 53 in the drive controllers Dct1 to Dctn by using the drive command path P1.

Here, if the communication unit 26 in the second library controller Lct2 also cannot transmit and instructions to and from any one of the communication units 33 to 53 in the drive controllers Dct1 to Dctn, it is determined in step S75 that the first drive command path P1 is faulty, and in step S78, the active drive command path is switched from the currently used first drive command path P1 to the reserve second drive command path P2, after which the process is terminated.

In this case, if, for example, the communication with the communication unit 33 in the drive controller Dct1 is possible, but the communication with any one of the communication units 43 to 53 in the drive controllers Dct2 to Dctn is not possible, then there is the possibility that the inter-Dct connecting drive command path PD1 or PD2 connecting between the drive controllers Dct1 and Dct2 is faulty. Here, provisions may be made to detect the failure of the inter-Dct connecting drive command path PD1 or PD2 by checking if the communication with the communication units 43 to 53 in the drive controllers Dct2 to Dctn becomes possible when the drive command path is switched to the standby drive command path.

On the other hand, if the communication unit 26 in the second library controller Lct2 can transmit and receive instructions to and from any one of the communication units 33 to 53 in the drive controllers Dct1 to Dctn, it is determined in step S76 that the first port 14 on the first library controller Lct1 is faulty, and, in step S77, the faulty state of the first port 14 is stored in the storage part 11; then, the active drive command path is switched from the currently used first drive command path P1 to the reserve second drive command path P2, after which the process is terminated.

According to the library apparatus of the present invention, even when a failure occurs in any one of the constituent elements of the library apparatus, the entire operation of the library apparatus can be continued uninterrupted.

It is also possible to identify the source of the failure. This serves to prevent non-failing parts from being replaced as has been the case with the prior art.

The present invention can be applied to a library apparatus for writing and reading data recorded on a recording medium such as a magnetic tape, a magnetic disk, or a magneto-optical disk.

While the invention has been described with reference to specific embodiments chosen for purposes of illustration, it should be apparent that numerous modifications could be made thereto, by those skilled in the art, without departing from the basic concept and scope of the invention.

What is claimed is:

1. A library apparatus comprising: a library controller which controls the entire operation in accordance with control instructions from a host; one or more drive controllers each of which controls a storage medium drive unit connected thereto in accordance with control instructions from said library controller; and a drive command path which connects between said library controller and said drive controllers, wherein
said library controller, said drive command path, and a library controller port to be connected to said drive command path are each configured in a redundant configuration.

2. A library apparatus as claimed in claim 1, wherein
said drive command path is configured redundantly by duplicating a first drive command path with a second drive command path, and
said library controller port is configured redundantly by duplicating a library controller first port with a library controller second port on each of said redundantly configured library controllers, and wherein
said library controller first port and said library controller second port are connected to said first drive command path and said second drive command path, respectively.

3. A library apparatus as claimed in claim 2, comprising a source-of-failure determining section for determining the source of a failure occurring in at least any one of said library controller, said drive command path, and said library controller port.

4. A library apparatus as claimed in claim 3, wherein said library controller and said drive controllers each include a communication section for communicating with each other, and wherein
said source-of-failure determining section detects the occurrence of said failure when an abnormality occurs in the communication between said communication sections.

5. A library apparatus as claimed in claim 2, wherein drive controller ports to be connected to said drive command path are each configured redundantly by duplicating a drive controller first port with a drive controller second port on each of said one or more drive controllers, and wherein
said drive controller first ports on said drive controllers are connected in parallel for connection to said first drive command path, and said drive controller second ports on said drive controllers are connected in parallel for connection to said second drive command path.

6. A library apparatus as claimed in claim 5, comprising a source-of-failure determining section for determining the source of a failure occurring in at least any one of said library controller, said drive controllers, said drive command path, said library controller port, and said drive controller ports.

7. A library apparatus as claimed in claim 6, wherein said library controller and said drive controllers each include a communication section for communicating with each other, and wherein
said source-of-failure determining section detects the occurrence of said failure when an abnormality occurs in the communication between said communication sections.
